(19) United States
(12) Patent Application Publication
(10) Pub. No.: US 2004/0148294 A1
(43) Pub. Date: Jul. 29, 2004

(54) Method of managing property development

(76) Inventors: Perry Wilkie, South Perth WA (AU); Brian Bernard Wilkie, Jolly Lookout QLD (AU); Geoffrey Stewart Jamieson, Bulimba QLD (AU)

Correspondence Address: SHOEMAKER AND MATTARE, LTD, 10 POST OFFICE ROAD - SUITE 110, SILVER SPRING, MD, 20910, US

(21) Appl. No.: 10/473,594

(22) PCT Filed: Mar. 4, 2002
(86) PCT No.: PCT/AU02/00239

(30) Foreign Application Priority Data
Apr. 11, 2001 (AU) PR 4360
Jul. 17, 2001 (AU) PR 6432
Dec. 17, 2001 (AU) PR 9555

(51) Int. Cl. G06F 7/00

(52) U.S. Cl. 707/100

(57) ABSTRACT

A computerised method for developing real property a land owner, builder, end buyers and a development manager are given participatory roles in the development process wherein returns produced by the development of land and realisation of development rights attaching to land are accesible to the land owner and other profit participants; realisation is not limited to receipt of a return on the land value only through the disposition of the land to a developer, and wherein the development can be carried out on a computer generated model of the land together with any improvements thereon and official titles to the real property can be issued by relevant authorities and a financial settlement able to occur on the titles prior to commencing and or completing any civil works or construction on the land.

### FIELD OF THE INVENTION

This invention relates to real property in particular but not limited to a computerised method of real property development wherein the development can be carried out on a computer model of the land and proposed improvements incorporated into a geographical model and information system and titles to real property can be officially issued and a financial settlement of the issued title effected prior to commencing and or completing any civil works or construction on the land.

### BACKGROUND OF THE INVENTION

In traditional property development models, a single development entity has the conduct of the process from the point of land acquisition to disposal of the completed product (be that residential, commercial, industrial or retail product).

Development sites are acquired from land owners under conditional contracts or similar option arrangements so that the acquisition of the land is conditional upon satisfaction of development preconditions such as the obtaining of approvals, satisfactory results of property due diligence investigations and feasibility studies to establish the viability of the proposed development.

As a consequence, the first step in the traditional development mechanism is generally site acquisition involving a long term contract or option arrangement with a land owner under which the land owner will receive a return prior to commencement of development but after the developer has satisfied itself that the preconditions for development to proceed have been, or are capable of being met The land owner's return is a return against the value of the land only and does not include any components of the profit that may ultimately be derived from the development of the land (in the ordinary process of land development).

There is limited accessibility for land owners to the development process and no direct participation in development profit generated from the use of the land for development.

The traditional development mechanism offers limited benefits in terms of balance sheet enhancement for corporate and other land owners by comparison with the present invention.

In the traditional development mechanism site acquisition risk is a key component of the development process.

In the traditional development mechanism, the developer carries the financial risk associated with meeting costs of development from site acquisition to disposal of product.

The developer will normally establish a financing facility with a lender to fund costs of purchasing land, obtaining development approvals, paying consultants, producing and establishing feasibility studies and conducting due diligence investigations (unless the developer commits its own equity to this process). In many instances lenders require an equity precommitment from a developer before funds will be advanced. This commitment can, of itself, restrict the scope or quality of a development proposal by limiting the available financial resources of the developer.

The developer's financier will also be asked to fund construction costs payable to the project builder and the financier will enter into direct contractual arrangements (usually in the form of a side deed) with the project builder to secure the financier's position in the event of default by the developer under the loan facility—essentially this allows the financier to step into the developer's shoes and control the building contract with the project builder if the developer defaults.

A defining characteristic of the traditional development mechanism is, accordingly, a single financing entity (or a single consortium of financiers) contracting with the developer and providing loan facilities for the purpose of funding development costs. That financier takes a funding risk in respect of the project but is secured against the project land and other assets of the developer or related entities or promoters to cover that risk.

The developer incurs and carries costs (generally interest and other charges) in respect of loan facilities given by the project financier from the point of acquisition of the site (if that acquisition cost is financed) to repayment of the financing facilities from proceeds realised from sale of development product to end buyers. In large scale single or mixed use developments that may take anywhere between 1 to 3 years (or longer) to complete, there are significant financing costs to be factored into any project feasibility and these costs reduce net profit in the hands of the developer as they are met or repaid from the proceeds of sale of development product and must be absorbed or carried until then.

The developer will work up a development concept for a site and seek to sell that concept on the market.

A development concept may be confined by feasibility studies based on the financial risk and project costs inherent in the traditional development mechanism. Expected development return using the traditional cycle may be somewhere between 25-35% which, by comparison with the present development strategy and subject business system, is a narrow return. This results in a reduction in flexibilty to meet market demands and provide better quality development product. That is, there is less ability for the developer to provide market incentives for buyers to purchase as there is little project profit to “share” with end buyers. To do so, the developer must radically alter the development concept itself to either provide greater numbers of product at reduced costs (generally with a reduction in quality) or to move the design concept into niche markets with comparatively shallower demand.

In the traditional development process the developer enters into a single construction contract with the project builder.

Funding the construction risk is the developer's responsibility under the terms of its construction contract. The developer will often seek to mitigate that risk through funding the cost under finance facilities. However, ultimately, the land or other assets of the developer are still at risk.

End buyers of product have no direct relationship with the project builder (other than perhaps to allow that builder access to rectify defects at the end of construction).

The receipt of return from the project to the developer is entirely dependent upon completion of construction of the relevant project works. Accordingly, the existence of the builder and any matters affecting construction timing have a direct impact on the development and may have an adverse affect on net return to the developer. Such matters may include weather, industrial action, cost blowouts or variations, materials availability, and other factors.

In the traditional development mechanism, the creation of titles to development product and the obtaining of relevant approvals for subdivision of the development site is tied to completion of construction works.

Accordingly, the point at which buyers of development product can be called upon to complete sales contracts is linked to completion of construction under the development approvals obtained for the project.

Non-compliance with development approvals for construction adversely affects the ability of the developer to comply with approvals obtained for subdivision of the development site. In turn, this will delay creation of titles and return of profit through the settlement of sales to end buyers. It also increases exposure to impacts from other project risk factors.

Under the traditional development mechanism, a developer may enter into pre-sales commitments with buyers under “off the plan” sales contracts or similar contractual arrangements that provide for the buyer to pay the full purchase price for development product only upon completion of construction and provision of lawful occupancy. Development profit is not received in the hands of the developer until that time. Buyers of completed development product under the traditional development method do not share in project profit (other than to a very limited extent where discounts against list prices reduce ultimate profit in the hands of the developer).

The risk of buyer default due to a change in the buyer's personal or financial circumstances or a change in market conditions is carried by the developer from the commencement of the project and signing of buyers under pre-sales contracts through to completion of construction works, the provision of titles and rights to occupancy of completed development product.

The traditional development mechanism does not provide for significant buyer involvement in the feasibility and design process.

Because developers work within comparatively narrow profit margins, there is a limit to the degree of variation or input that end buyers of product can be allowed to have at commencement of the design stage. This is also reflected in the limited incentives offered to end buyers in the marketing of development product and the retention of profit realised on the sale of development product, including management rights for development product. Traditionally developers sell management rights in projects and retain the money received from that sale without distributing any of those proceeds back into the hands of a representative body or end buyers. Under the present invention, because there is a significantly increased return on costs in the hands of the land owner, the proceeds realised from the sale of management rights can be offered to or retained by a representative body or end buyers with consequent savings on levies payable to the representative body or subsidisation of other ownership costs as an incentive for end buyers.

Limited buyer input to concept and design under the traditional development method, should be contrasted with the present development strategy where initial market appraisals intensely seek to establish what buyer demands are for product with the development design being driven by that assessment rather than a developer's design concept being imposed upon a market based on general statements or investigations of market requirements.

An analysis of traditional development mechanisms herein described shows they are limited by the following factors:

There is limited accessibility to the benefits of development for land owners without development expertise or the ability to participate in development of their land—the “development opportunity” is seldom realised by the land owners.

In a traditional development method, the lack of participation in the development process and realised development profit means that balance sheet enhancement for corporate land owners is limited to the price achievable on disposal of the land to a development entity or, in some cases, returns from joint venture or similar arrangements using a traditional development method. In contrast, under the present invention the parameters for balance sheet enhancement are expanded as the corporate land owner participates in the development profit and receives returns earlier.

One development entity carries all project risk from site acquisition to realisation of development product. Although elements of that risk may be disbursed or borne for periods of time by other parties (e.g. a financier in the case of funding risk, or a builder in the case of construction risk), ultimately, liability rests with the developer for all of these risks as those other parties secure their positions contractually and through other mechanisms (e.g. security over land or other assets).

The costs of funding development (over and above the developers equity) are generally provided by one financier (or one consortium of financiers in larger projects). This is reflected in the cost of provision of financing facilities to the developer and in turn that cost is included in development costs, reducing potential returns. Cost pressures impose pressure on developers at the expense of product quality or diversity.

The development cycle (in terms of realising returns) is significantly longer than it needs to be. Return to the developer is not delivered until constructed development product has been sold and payments received under sales contracts from end buyers. As noted, end buyers do not share in the development return other than to a very limited extent if discounts or incentives are offered by the developer and these are, in general, limited by the narrower returns and greater cost pressures inherent in the traditional development method. There is no end buyer participation in profit sharing in the sense of the end buyers being development partners.

The length of the development cycle means that net return to a developer under the traditional mechanisms is susceptible to adverse impact from:

(a) delays to construction;

(b) default on the part of the project builder or corporate/entity risk (i.e. builder insolvency);

(c) costs of project funding from site acquisition to completion of construction and sale of end product and increases in the developer's cost base caused by the other factors listed here;

(d) delay in obtaining regulatory approvals required for a project which will push out the point of return of development profit by delaying commencement of construction and ultimately creation of titles on which contracts can be settled;

(e) changes in market demands; and

(f) a limited ability to accommodate market demands in early design and conceptual work.

(g) buyers pay full stamp duty on the completed value of constructed product.

### OBJECT OF THE INVENTION

It is therefore an object of the present invention to seek to ameliorate some of the disadvantages and limitations of traditional prior art methods of developing real property or to at least provide the public with an alternative and useful choice.

### STATEMENT OF THE INVENTION

According therefore to one but not necessarily the only aspect, the invention resides in a computerised method for developing real property wherein a land owner, builder, end buyers and a development manager are given participatory roles in the development process wherein returns produced by the development of land and realisation of development rights attaching to land are accessible to the land owner and other profit participants; realisation is not limited to receipt of a return on the land value only through the disposition of the land to a developer, and wherein the development can be carried out on a computer generated model of the land together with any improvements thereon and official titles to the real property can be issued by relevant authorities and a financial settlement able to occur on the titles prior to commencing and or completing any civil works or construction on the land, the method includes the steps of:

preserving the development potential and development rights in a land parcel for realisation by the land owner by appointing a development manager entrusted to obtain on behalf of the land owner requisite municipal and statutory approvals for development, construction and sub-division of land to create flat land in two dimensions, strata or volumetric freehold titles corresponding to the dimensions of intended residential, commercial, industrial or retail units or dwellings, the development manager selecting a construction manger and/or builder for the development of the land;

generating by computerised means a spatially accurate geographical digital terrain model of the land, overlaid by cadastral boundaries;

computer assisted drafting of civil structural and architectural building designs, and overlaying of the building designs on the model;

entering dimensions and descriptions of proposed titles to be created by subdivision or reconfiguration of the land encompassing the building designs;

obtaining initial official issuance of titles to the proposed flat land, strata or volumetric freehold titles;

wherein the computerised means incorporates the model, building design and title information into a geographical information system database; the geographical information system adapted to provide relevant data for and to coordinate the further steps of:

establishing a representative body prior to any construction in the case of strata or volumetric titles or construction or other underlying civil works in the case of two dimensional land sub-division;

marketing and offering for sale by the development manager or other agent appointed on behalf of the land owner, the sub-divided or reconfigured lots to buyers;

the buyers entering into building contracts with one or more builders for the construction of improvements on their lots;

settling pre-sales contracts with the buyers under which the title to the flat land, strata or volumetric freehold lots are transferred to the buyers and they become registered proprietors of their lots prior to construction of improvements or underlying civil works on or in those lots;

conveyance of the ownership in the titles to the lots to the buyers of the lots prior to construction commencing, and subject to development leases and covenants referred to here;

leasing for development by the buyers of the purchased lots to a construction manager or the development manager, said development leases subject to any covenant or registered instrument required by relevant local or state authorities imposing restrictions on the use of the lots between the creation of the titles and completion of construction and occupancy of the lots;

the development manager or the construction manager contracting with one or more builders to build buildings on the leased lots, or supervising one or more builder contractually engaged by the buyers of titles or a representative body, for the benefit of all or any of those parties who engage a builder;

conducting a computer survey audit to verify that the structural elements comprising buildings and other improvements constructed are on or within the boundaries of the subdivided or reconfigured titles with progressive field variations being fed into the geographical information system database wherein construction is progressed in accordance with directions and parameters determined by the geographical information system at all stages;

consensual termination of the development leases between the buyers and the construction manager and/or the development manager, and the lifting of covenants as to the use of those lots on satisfactory completion of the buildings wherein the lots and the buildings thereon can be returned to and be occupied by the buyers.

In preference there is a development management agreement in the form of a written contract between the development manager and the land owner for the development manager to obtain the appropriate requisite municipal sub-division or reconfiguration permits, development and building consents and approvals on behalf of the land owner.

The construction manager and the builder(s) can be one and the same entity.

The requisite permits, consents and approvals can be for sub-dividing land for building ground based dwellings typically residential housing or can be for layered strata or volumetric lots in respect of multi-story buildings, typically high rise apartments or units for residential, retail, industrial or commercial use.

The process of creating titles for lots may be staged within any single building or project site with construction arrangements keyed to the progressive release of titles.

Preferably the marketing and offering for sale of the sub-divided or reconfigured lots is through a realty agent, accountants, financial planners, investment advisors or any other agent, either by traditional methods of sale or via a dedicated Internet facilitated portal website, appointed to market and sell the lots to prospective buyers under contracts that require buyers to accept title to the flat land, strata or volumetric lots prior to the commencement of construction of the improvements or civil works within or on those lots.

Preferably the development leases between the buyers and the construction manager are for terms appropriate for completion of buildings or civil works. More preferably the lease includes an option to extend the lease if building activity extends beyond the term of the initial lease.

Preferably each development lease incorporates or recognises the existence of a construction contract or arrangement between the individual buyers and the builder which is managed by the development manager on behalf of the buyers for dealings with the construction manager or builder.

Preferably the representative body is appointed as the agent of each buyer for any dealings with the construction manager, builder or the development manager in respect of building works and/or entering into a construction contract for building works.

Preferably there is a facility for the buyers to make payments, typically progress payments, to the builder(s) during the building period or in the alternative to a construction manager or a development manager who has engaged the builder.

Preferably the payments are proportionate to the value of a construction contract or arrangement between the individual buyer and the builder or a construction manager or development manager who has engaged the builder and is based on the unit entitlement of the relevant strata or volumetric freehold lots in the case of multi-level buildings or a quantity surveyor's determination of the proportionate value of building works for which each buyer is responsible.

Timing of payments may be linked to cash flow requirements for undertaking building works and/or cost to complete certifications in respect of building works.

In another aspect the invention resides in real property developed according to the method for developing real property as herein above described.

In yet another aspect the invention resides in the building constructed on the real property developed according to the method for developing real property as hereinabove described.

### BRIEF DESCRIPTION OF THE DRAWINGS

In order that the invention be more readily understood and put into practical effect, reference will now be made to the accompanying illustrations wherein:

FIGS. 1 and 2 comprise a flow diagram of a preferred method of the invention according to Example 1.

### DETAILED DESCRIPTION

### EXAMPLE 1

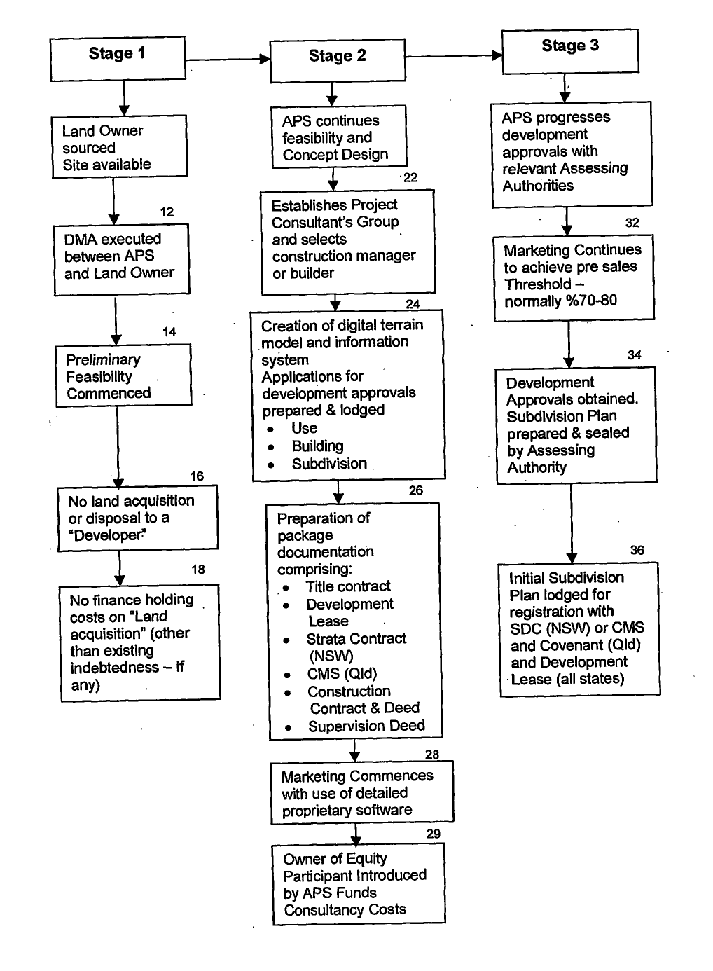

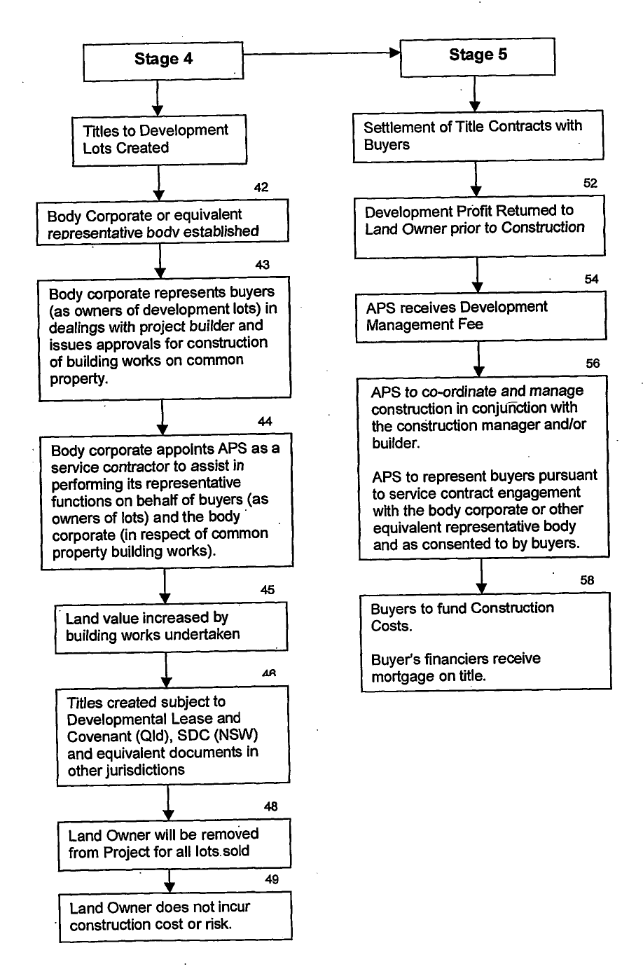

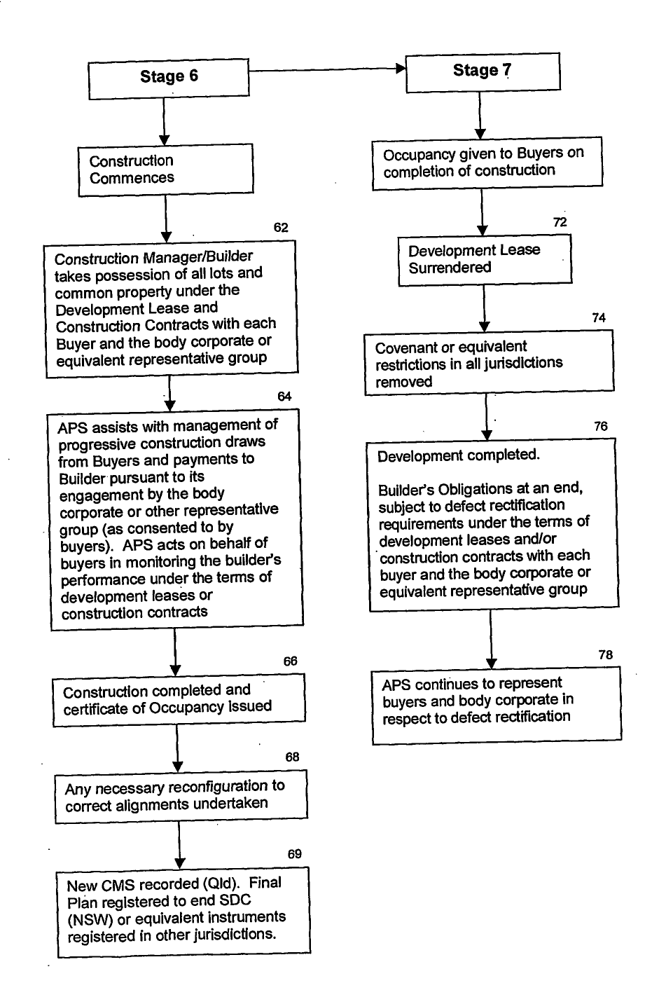

FIGS. 1 and 2 shows a flow diagram of a preferred method of developing real property according to Example 1.

STAGE 1: A suitable site is identified by a development manager wherein negotiations are commenced with the owner of the land (10). A development management agreement is entered into between the development manager and the land owner under which the development manager assists the land owner to improve the value of the land by obtaining necessary development approvals and consents and establishing a development concept for the land (12). The development manager holds no interest in the land and is paid a fee for the provision of services to the land owner as an independent contractor. The development management agreement provides the development manager with the requisite authority to conduct a preliminary feasibility study of the proposed development for the site (14). Importantly, it must be realised that there is no transfer of title in the land to the development manager or the existence of any finance holding costs in respect of any land acquisition at this stage (16,18).

STAGE 2: At this stage, the development manager completes its initial feasibility studies and concept designs (20) which includes input from potential buyers on their requirements. The development manager uses proprietary detailed computer models to establish the feasibility of the project and convince the land owner to proceed. Preferably also at this stage, the development manager establishes a project consultant group comprising various members such as surveyors, planners, architects and interior designers and selects the construction manager and/or builder (22). The development manager then prepares and lodges various submissions for development approvals in relation to use of land, type of dwellings to be erected and type of sub-division (24). This will involve the creation of a spatially accurate geographical digital terrain model and information system and input of the civil structural and architectural design of buildings and improvements shown on design concepts, overlaying of boundaries and descriptions of titles to be created by the subdivision or reconfiguration of the development land with respect to the building designs within the geographical model and information system and the preparation and submission of survey plans to the relevant assessing authority for sealing to allow the creation of the flat land strata or volumetric freehold titles to lots the subject of pre-sales contracts with buyers, before construction of improvements or in the case of flat land developments the commencement of civil works.

Documentation is then prepared in relation to each lot including inter alia, title contacts, development leases, strata contacts if required by local legislation, community management statements, building management statements, construction contracts and deeds, supervision deeds (26).

Marketing of the titled lots is by appointed financial advisors, investment advisors, accountants, marketing group, realty or other agents (28) using the present invention. Detailed proprietary computer models are used to assist in the marketing of the lots. Where owner finance or equity participation is introduced by the development manager, the funds arranged at this stage can be used to defray the costs of the consultants engaged thus far (29).

STAGE 3: The development manager continues to progress the applications for development approvals with the relevant assessing authorities and municipal bodies (30). The realty agent or property marketer continues to sell properties “off the plan” so to speak until a presale threshold, preferably in the order of 70% to 80% is achieved (32).

In the meantime, it is envisaged that the various development approvals and permits will be obtained and the sub-division or reconfiguration plans will be prepared and sealed by the relevant assessing and municipal authorities (34).

The sealed sub-division or reconfiguration plans are then lodged for registration together with the development leases between the buyers and the construction manager with the appropriate authorities (36).

STAGE 4: Titles to the sub-divided or reconfigured lots are created and are issued to the land owner (40). At this stage, a representative body can also be established for a strata-title development which will have the power to represent buyers (as owner of the subdivided or reconfigured lots) and the representative body, provide access to contractors and issue approvals for construction of building works on or in common property (which may include landscaping and the installation of service infrastructure in addition to construction of building elements) (42). Completion of common property building works, including landscaping and general maintenance of the development site, invariably results in the improvement to the value of the property (45). Buyers (as owners of lots) appoint the representative body as their agent to act on their behalf in respect of building works undertaken on or in the subdivided or reconfigured lots that they own. The representative body also acts in its own right in respect of construction works undertaken on or in common property. The representative body engages the development manager as a service contractor to assist it in performing its functions in respect of construction works (both in its own right and in its representative capacity acting for buyers) (43) (44) (56). It is important to note that the titles and common properly created are also subject to the development lease and to various covenants as to the type of building allowed which have been previously approved by the relevant municipal authorities (46). The land owner will after the lots are sold and titles transferred to the buyers, be removed from the development process (48). In this way, the land owner, does not incur construction costs or risks (other than in respect of any unsold lots of which the land owner remains the registered proprietor) which are borne by the buyers and their individual finances from this point forwards (49). This is a major advantage of the present method over the traditional model of development wherein there is a property developer who effectively steps into the shoes of the land owner on purchasing the property from the land owner and carries project financing cost and risk.

STAGE 5: As the lots are sold and the contracts of sale are settled with the buyers (50), the balance of sale monies can be returned to the original land owner and buyers in their respective shares as “development” profit prior to the commencement of any construction activity (52). In addition, the development manager also receives its development management fees from the balance of sales funds (54). The development manager works with a construction manager responsible for managing the construction on or in the lots or the builder and advises the buyers of their initial and subsequent payments in respect of construction works (56). In effect, the construction costs are borne by the buyers or their lending institutions who are secured by holding the mortgages on title (58). It is possible that in some jurisdictions the development manager and the construction manager may be one in the same entity.

STAGE 6: Construction is able to be commenced on each lot (60). Builders supervised by the construction manager or development manager can take and secure possession of the sites through the development leases and contracts each particular buyer or representative body has for construction works (62). The development manager assists the construction manager or builder(s) to coordinate the process of buyers making progressive construction draws to meet proportionate payments towards building costs. There is a continuing involvement for the development manager with the construction entity and buyers in this process which is a distinctive feature of the system. The traditional development method would see this liaison conducted by the development entity throughout the development project whereas under the present system the land owner has stepped out of the process and the buyers then deal with the builder(s) (a second entity) and the development manager (64) who acts at this stage on behalf of the representative body and the end buyers. The development manager works with the builder to achieve cost savings on construction works with those savings being incorporated in the delivery of a better product to end buyers or other incentives for the benefit of buyers.

On completion of construction activity, the certificate of occupancy can be issued in respect of each completed building and lot (66). Any necessary sub-divisions can be undertaken to correct any encroachments or misalignments evident after construction is completed but before occupancy is given (68).

New community management statements or other registrable instruments can be recorded and final plans registered to end the strata development contract in relevant jurisdictions (69).

STAGE 7: On completion of construction activity, the site and the lots can be returned to and occupied by the individual buyers (70). At this stage, as access to the site is no longer required, the development leases are also surrendered (72). Where conditionally imposed, any covenants over titles are also removed. At this point, the builders obligations are also at an end subject, to any rectification work which may be required or has been stipulated as a condition of the building contract (74,76). The development manager continues to represent buyers and the representative body in respect of any rectification work (78)

### Advantages

The advantages of the present subject development strategy over traditional development mechanisms are set out in this section.

There is no single developer in the subject development strategy and no one party that carries all project risk. This introduces significant flexibility to the development process.

Because return on costs is received at the point of settlement of the transfer of titles to individual buyers, which occurs prior to commencement of construction, return on costs is significantly greater than under the traditional development mechanism. The land owner's return on equity is also significantly higher and the land owner participates in development profit in a way that is not inherent to the traditional development mechanisms.

The creation of titles prior to construction adds significant value to the holdings of the land owner.

The increased return on costs and equity together with increased value flowing from creation of titles prior to construction, offers significantly increased balance sheet enhancement opportunities for corporate land owners over and above the benefits achievable under a traditional development mechanism. The parameters for balance sheet enhancement under the present invention are not limited by the price achievable on an acquisition of the land prior to completion of construction and development but are expanded to incorporate development profit. Even if a corporate land owner was to enter into joint venture arrangements for development of its land under a traditional development mechanism, the point of realisation of return on costs is delayed under the traditional development mechanism when compared to the accelerated receipt of returns under the present invention. The present invention offers significant advantages for corporate land owners in terms of the timing of receipt of asset realisation and profit participation.

In addition the land owner has no exposure to construction costs or risk (other than to the extent that flat land (in 2 dimensions) strata or volumetric freehold titles have not been sold). The land owner's exposure to market risk and in particular, changes to market demand during the course of construction of a project is reduced as the impact of those changes is mitigated by the earlier return of development profit in the hands of the land owner.

The significantly greater return on costs introduces much greater flexibility in designing a concept for any given site to meet with the express wishes of buyers in a defined market and to move the concept into different markets. The higher return on costs means that buyers can participate in sharing project profit and greater incentives can be offered to buyers in terms of the quality of the development product, its basic design parameters and the ability to offer a range of incentives to buyers while still providing development returns to the land owner in excess of those that would be achieved under traditional development methods.

Improved development product leads to better rental returns and better opportunities for capital growth. In addition, the timing of transfer of title to completed product and its relationship to subsequent construction of building works allows better financial and tax planning on the part of endbuyers. In the traditional development method, buyers pay an initial deposit and wait for anywhere up to 3 years without having certainty of commitment to the timing of completion of the transfer of ownership of the completed development product to them. In the present invention, the period between execution of contracts for the acquisition of titles and settlement of those contracts is significantly reduced with the result that it is easier to forecast the point at which financing and commitment of funds will be required on the part of endbuyers. Within the present invention, the transfer of title also crystallises the construction program and allows buyers to assess their financial obligations in respect of progressive draw downs for construction works against a set construction program. Commitment dates for funds are established at this point and with a higher degree of certainty than under the traditional development mechanisms.

The flexibility achieved by having an earlier return of development profit and a higher return on costs also introduces the ability to subsidise ownership costs that would otherwise fall to be met by end buyers in the traditional development method. This includes fees and levies payable to a representative body, local authority rates and other ownership expenses. These fees can be offset by diversion of a share of development profit to the endbuyers, particularly from the retention of proceeds from the sale of management rights (which in the traditional development method are retained by the project developer) in the hands of the representative body. In addition, end buyers can participate directly in development profit and savings on construction costs through, direct cash payment, improved product, or other incentives. The present invention allows end buyers to have the benefits of ownership of freehold title at an early point in the development process without incurring additional costs as a result and providing the opportunity to reduce ongoing ownership costs after completion of construction works. In contrast owners under the traditional development method carry these costs without developer sudsidisation. Increases in value to the titles through construction process are realisable and can be utilised by the buyers in contrast to the position of a single development entity in the traditional development process that retains ownership of the development parcel through the construction process but cannot utilise increases in the value of that land caused by construction of improvements.

The significantly higher returns on development costs achievable under the subject development strategy introduce far greater scope for buyer input into the initial design concept and the ability to incorporate specific buyer requirements at an early pre-conceptual stage of the project. The higher return also allows significantly better quality product to be produced while not resulting in the development being priced out of competing markets as a consequence.

Buyers receive considerable stamp duty benefits from acquiring under the subject development strategy as they are paying duty on the value of the flat land, strata or volumetric lot (as the case requires) rather than the full value of the constructed apartment.

As noted above, development return on costs is received at the point immediately following creation of titles when buyers settle the transfer of title to their development lot under sales contracts. Accordingly, development return is not dependent upon construction timetables or subject to the potential adverse impacts of:

1) builder default;

2) construction delay; or

3) buyer default during the construction period.

Under the subject development strategy, all funding risk is carried by the financiers of individual buyers through the provision of retail financing from banks. There is no single construction or project development facility entered into between the land owner (or any other participant) and financiers. In turn this means that the financing costs are not costs of the development as such but rather are costs incurred by end buyers at a retail financing level. This avoids a duplication of financing sources and allows a more efficient delivery of financing services to project development.

In any given project, there may be a number of end retail financiers to buyers and accordingly there may be multiple financiers providing funds to meet construction costs for the development concept, disbursing this risk as a result.

Under the present invention, the completion of a better quality of development product and association with the financing of that product raises banks' community profile and levels of satisfaction with borrowers. The ability for multiple financiers to be involved on a single development project allows financiers greater scope for adjusting and controlling their risk position. In addition, the provision of individual titles in conjunction with the retail financing of construction costs provides a better loan to value ratio through the course of construction on or within titles than would be the position for a single financier of a development project providing construction draws under the traditional method through completion of all construction works.

In the traditional development mechanism, the developer contracts with a single project builder and carries all risk associated with the provision of construction funding (through facilities provided to that developer under a single loan facility). In the subject development strategy, there is no direct relationship between the project builder and the original land owner (other than for construction on or in lots retained by the original land owner). The development manager works with the construction manager and builder on behalf of end buyers and representative bodies to ensure that any representations and contractual obligations incurred by the original land owner through the marketing of the development concept to end Purchasers are complied with and that buyers interests are protected.

The project builder receives payment for its construction works from each individual buyer (proportionately) and accordingly, this risk is not carried by the land owner.

In addition, because there may be multiple retail financiers for end buyers, the builders payment risk is of a significantly different profile to that under the traditional development mechanism. In effect, that payment risk (from the builder's perspective) is mitigated by the possibility of having a number of financiers involved in funding the project.

Because the present invention involves establishment of relationships with selected builders there is generally no tender process associated with the undertaking of construction works with a consequent benefit in terms of certainty for the project builder. The development manager may establish an alliance with a particular builder to undertake construction works in the development system with an increase in continuity of work for the builder. This increased certainty in obtaining and maintaining work allows the builder to better price construction works without cost pressures jeopardising design or quality of development product—the increased return on costs in the hand of the land owner allows greater margins for the builder in submitting its price for construction works and a higher return to builders using the present invention. Association with construction of better development product under the present invention also raises the builder's community profile.

From the perspective of end buyers and their retail financiers, there is no additional risk in terms of construction default because the subject arranges insurance in respect of any default by the builder and allows the subject to maintain control of the building process so that if a builder was to default, an alternative contractor can be engaged with no additional costs incurred to the end buyers. The provision of this insurance policy also mitigates against any risk that would normally be carried by a developer in a traditional mechanism that construction cost increases could in effect reduce development profit in the hands of the developer.

The ability to introduce better market input in the early conceptual and design stages allows for a tailoring of development product to meet market demands with far greater flexibility than under the traditional method and the better quality development product flows through to better lifestyle benefits for occupiers of development product.

For marketing agents, the present invention offers an earlier return on commission than would be achievable under the traditional development mechanism, access to better quality stock with a point of difference and differentiation from competing product in the market, an opportunity to be involved in the sale of better quality product with consequent profile enhancement and increased level of client satisfaction, all of which have flow on benefits to the business of the marketing agent.

For members of the valuation industry, their participation is called for at a very early stage. Property holdings of the land owner are driven up in value at an earlier stage by the system by creation of titles form the base development parcel prior to construction of works. There is a consequent flow on of progressive increases in value as construction proceeds with that value increase being realisable by the buyers at that point—under the traditional development mechanism because there is only one owner of the land development parcel through the construction process, increases in value to that land (which is subject to a series of contractual obligations to endbuyers) cannot be utilised by the land owner at that point in the same way that end buyers under the present invention can leverage against the created title as it increases in value during construction.

From the point of view of Government and Regulatory Authorities, the present invention offers a far more efficient use of existing legislative mechanisms. The more efficient use of these legislative mechanisms for the benefit of multiple participants in the development process (rather than a single or dominant entity) enhances Government profile and objectives in the enhancement of economic development opportunities with a diminished risk profile and better social and lifestyle returns to the community.

The characteristic of the present invention where participation in the development process and development profit is spread across multiple entities (the land owner, consultants, builder, financier, and end buyer) represents a more equitable basis for development within the community and participation in that development by community members.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps. The term, “construction entity” may include “the construction manger” or “the builder”. The term, “representative body” may include “a body corporate”, “a management group” or “other representative group of the buyers”. The term “volumetric” includes “vacant air strata” or “unoccupied space”.

1. A computerised method for developing real property wherein the development can be carried out on a computer generated model of the land and official titles can be issued prior to commencing or completing any civil works or construction, the method including the steps of:
generating by computerised means a spatially accurate geographical digital terrain model of the land, overlaid by cadastral boundaries;
computer assisted drafting of civil structural and architectural building designs, and overlaying of the building designs on the model;
entering dimensions and descriptions of proposed titles to be created by subdivision or reconfiguration of the land encompassing the building designs;
obtaining initial official issuance of titles to the proposed flat land, strata or volumetric freehold titles, and
wherein the computerised means incorporates the model, building design and title information into a geographical information system database.

2. The method of claim 1, wherein the geographical information system is adapted to provide relevant data for and to coordinate the further steps of:
establishing a representative body prior to any construction in the case of strata or volumetric titles or construction or other underlying civil works in the case of two dimensional land sub-division.

3. The method of claim 2, including the further steps of;
marketing and offering for sale by the development manager or other agent appointed on behalf of the land owner, the sub-divided or reconfigured lots to buyers;
the buyers entering into building contracts with one or more builders for the construction of improvements on their lots;
settling pre-sales contracts with the buyers under which the title to the flat land, strata or volumetric freehold lots are transferred to the buyers and they become registered proprietors of their lots prior to construction of improvements or underlying civil works on or in those lots, and
conveyance of the ownership in the titles to the lots to the buyers of the lots prior to construction commencing, and subject to development leases and covenants referred to herein.

4. The method of claim 3 including the further step of leasing for development by the buyers of the purchased lots to a construction manager or the development manager, said development leases subject to any covenant or registered instrument required by relevant local or state authorities imposing restrictions on the use of the lots between the creation of the titles and completion of construction and occupancy of the lots;
the development manager or the construction manager contracting with one or more builders to build buildings on the leased lots, or supervising one or more builders contractually engaged by the buyers of titles or a representative body, for the benefit of all or any of those parties who engage a builder.

5. The method of claim 4 including the further step of conducting a computer survey audit to verify that the structural elements comprising buildings and other improvements constructed are on or within the boundaries of the subdivided or reconfigured titles with progressive field variations being fed into the geographical information system database wherein construction is progressed in accordance with directions and parameters determined by the geographical information system at all stages.

6. The method of claim 5 including the further step of consensual termination of the development leases between the buyers and the construction manager and/or the development manager, and the lifting of covenants as to the use of those lots on satisfactory completion of the buildings wherein the lots and the buildings thereon can be returned to and be occupied by the buyers.

7. The method of any one of the above claims, wherein there is a development management agreement in the form of a written contract between the development manager and the land owner for the development manager to obtain the appropriate requisite municipal sub-division or reconfiguration permits, development and building consents and approvals on behalf of the land owner.

8. The method of any one of the above claims, wherein the construction manager and the builder(s) can be one and the same entity.

9. The method of any one of the above claims, wherein the requisite permits, consents and approvals can be for sub-dividing land for building ground based dwellings typically residential housing or can be for layered strata or volumetric lots in respect of multi-story buildings, typically high rise apartments or units for residential, retail, industrial or commercial use.

10. The method of any one of the above claims, wherein the process of creating titles for lots may be staged within any single building or project site with construction arrangements keyed to the progressive release of titles.

11. The method of any one of the above claims, wherein the marketing and offering for sale of the sub-divided or reconfigured lots is through a realty agent, accountants, financial planners, investment advisers or any other agent, either by traditional methods of sale or transacted via a dedicated Internet facilitated portal website, appointed to market and sell the lots to prospective buyers under contracts that require buyers to accept title to the flat land, strata or volumetric lots prior to the commencement of construction of the improvements or civil works within or on those lots.

12. The method of any one of the above claims, wherein the development leases between the buyers and the construction manager are for terms appropriate for completion of buildings or civil works, wherein the lease includes an option to extend the lease if building activity extends beyond the term of the initial lease.

13. The method of any one of the above claims, wherein each development lease incorporates or recognises the existence of a construction contract or arrangement between the individual buyers and the builder which is managed by the development manager on behalf of the buyers for dealings with the construction manager or builder.

14. The method of any one of the above claims, wherein the representative body is appointed as the agent of each buyer for any dealings with the construction manager, builder or the development manager in respect of building works and/or entering into a construction contract for building works.

15. The method of any one of the above claims, wherein there is a facility for the buyers to make payments, typically progress payments, to the builder(s) during the building period or in the alternative to a construction manager or a development manager who has engaged the builder.

16. The method of any one of the above claims, wherein the payments are proportionate to the value of a construction contract or arrangement between the individual buyer and the builder or a construction manager or development manager who has engaged the builder and is based on the unit entitlement of the relevant strata or volumetric freehold lots in the case of multi-level buildings or a quantity surveyor's determination of the proportionate value of building works for which each buyer is responsible.

17. The method of any one of the above claims, wherein the timing of payments may be linked to cash flow requirements for undertaking building works and/or cost to complete certifications in respect of building works.

18. Real property developed according to the method for developing real property substantially as herein described with reference to the accompanying diagrams.

19. A building constructed on the real property developed according to the method for developing real property substantially as herein described with reference to the accompanying diagrams.

20. A computerised method for developing real property wherein the development is carried out on a computer generated model of land and official titles are issued prior to commencing or completing any civil works or construction substantially as herein described with reference to the accompanying diagrams.
